(19) United States
(12) Patent Application Publication
(10) Pub. No.: US 2010/0147296 A1
(43) Pub. Date: Jun. 17, 2010

(54) Port Sealing Cartridge for Medical Ventilating and Aspirating Devices

(76) Inventors: John Brewer, Marietta, GA (US); Ilona F. Weart, Woodstock, GA (US); Cassandra E. Morris, Roswell, GA (US); Joe Gordon, Mansfield, MA (US); Stephen Gianelis, Abington, MA (US); David Zitnick, Providence, RI (US)

Correspondence Address: KIMBERLY-CLARK WORLDWIDE, INC.;Tara Pohlkotte, 2300 Winchester Rd., NEENAH, WI, 54956, US

(21) Appl. No.: 12/334,067

(22) Filed: Dec. 12, 2008

(51) Int. Cl. A62B 9/04

(52) U.S. Cl. 128/202.27

(57) ABSTRACT

There is provided a port sealing cartridge that allows for insertion of a catheter or other medical device into an endotracheal tube and thence the patient's lungs through an available access port. The port sealing cartridge has a primary and a secondary seal or collar that sequentially provide a pressure seal as a medical device is inserted through them and into the system. An optional tethered dust cover may also be used on the proximal end of the port seal cartridge. The port seal cartridge may desirably be fitted with a quick-connection so that it may be easily removed, disposed of and replaced. The port seal may be used for access to a patient's lungs with a bronchoalveolar catheter, bronchoscope or other medical device for treatment or sampling of the respiratory tract.

### BACKGROUND

Tracheal catheters are used to assist patient breathing during and after medical procedures until they are able to breathe successfully on their own and be removed from assisted breathing. One type of tracheal catheter, the endotracheal tube (ET tube), is inserted through the mouth of a patient and guided past the vocal cords and glottis into the trachea. Once the patient is intubated, the ET tube is connected to ventilators or respirators for mechanical ventilation of the lungs. The ventilator unit is connected to a hose set; the ventilation tubing or tubing circuit, delivering the ventilation gas to the patient as a ventilating system.

Removing secretions from the trachea-bronchial tree is an integral part of the care given to patients who are intubated and receiving mechanical or other artificial ventilation. Secretions can be excessive in some respiratory disorders and constitute a serious threat to the patient having such respiratory disorders. The presence of an endotracheal tube is a hindrance to the patient's efforts to clear secretions through natural coughing. In current medical practice, suction catheters are inserted into the lungs to clear such secretions from the patient's airway by suctioning.

Suctioning may be performed using an “open” or “closed” system. In the open system, the suction catheter is merely a flexible plastic tube that is inserted into the tracheal tube ventilating lumen with a source of suction connected to the proximal end of the suction catheter. The suction catheter is advanced as far as desired and suction is applied to remove secretions. Anything that the suction catheter touches before entering the lumen must be maintained in a sterile condition so a “sterile field” must be created on or next to the patient. The suction catheter must be carefully handled after it is used since it will be coated with the patient's secretions. In contrast, in the “closed” system, for example that disclosed in commonly owned U.S. Pat. No. 4,569,344, a device 10 which may be used to suction secretions uses a suction catheter 12 enclosed within a generally cylindrical plastic bag 14 to eliminate or minimize contamination of the suction catheter prior to use (FIG. 1). This is generally referred to as a “closed suction catheter” and is available under the trade name TRACH CARE® from BALLARD® Medical Products (Kimberly-Clark Corporation). As the patient requires artificial removal of secretions, the suction catheter 12 may be advanced through one end of the plastic bag 14, through a connecting fitting 16, into the tracheal tube and, if desired, into one of the main bronchi of the patient. The other, proximal end 17 of the suction catheter 12 is attached to a source of suction 19. Suction is applied to the proximal end 17 of the suction catheter 12 using a finger controlled valve 18 to remove the secretions. The other bronchus may likewise be aspirated. Secretions are thus drawn into the lumen of the suction catheter 12 and removed and the system remains closed. The suction catheter 12 is subsequently withdrawn from the tracheal tube and back into the plastic bag 14 to keep the circuit closed. Closed suction systems are generally preferred by healthcare providers since the provider is better protected from the patient's secretions. Closed suction systems are also easier and quicker to use since a sterile field need not be created each time the patient must be suctioned, as is required in open suction systems.

Many problems in tracheal care now focus on multiple needs of the patient and accommodation of multiple treatments, some to be performed at the same time. For example, for patients with low lung capacity (such as premature babies and adults suffering from emphysema), one problem is the removal of accumulated lung secretions without starving the patient for oxygen during the secretion removal process. One solution to this problem has been provided by commonly owned U.S. Pat. No. 5,735,271 which provides a multiple-access manifold mounted between the tracheal care device of U.S. Pat. No. 4,569,344, for example, and the ventilation circuit. This device is shown in FIG. 2.

In the exploded view of FIG. 2, an assembly 20 comprises an adaptor for defining a flow path therethrough for delivery of ventilating gasses to an intubated patient and for providing an access path for delivery to the intubated patient. The assembly 20 may contain an elbow type connector 22, a rotating manifold 33, and ports 28, 30 and 32. The elbow 22 has a distal port 24 that connects to a tracheal tube, a proximal port 26 for connection to a mechanical ventilator, and connects to the rotatable manifold 33.

In use, the multi-access manifold assembly 20 accommodates continual cyclic patient ventilation, independent of implementation by the health care provider of any other patient respiratory access procedure by the rotation of the ports 28, 30 into a position that allows direct and straight insertion to the tracheal tube. Access port 32 accommodates introduction of irrigation or wash liquid by which the exterior of a suction catheter 12, for example, is washed as the suction catheter 12 is withdrawn following use. Access ports 28 and 30 may be switched in position by rotating the manifold 33 to accommodate access by an accessory device, such as selective insertion and removal of a closed suction catheter 12 assembly, the suction catheter 12 of which removes secretions from the lungs and is then withdrawn into a generally cylindrical plastic bag 14. Access ports 28 and 32 can also accommodate an oxygenation catheter assembly, the catheter tube of which is used in the lungs to replace residual carbon dioxide with oxygen, and/or entry of temperature or pressure monitoring instruments or obtaining samples of sputum or gases and/or to allow insertion of visual inspection instruments.

It is important that the pressure in the patient ventilating system be maintained during any procedure and that once the procedure is completed the integrity and pressure of the system be maintained. Loss of pressure may result in breathing difficulty for the patient if air is not being delivered to the lungs and is instead merely leaking into the outside environment. Loss of pressure due to air leaking into the environment may also pose a health hazard for healthcare providers as they breath in proximity to the patient, should the patient be suffering from a communicable disease.

As can be seen in FIG. 2, the access ports may be provided with replaceable caps 34 that may be tethered to the device. These open access ports have performed adequately, but serve to open the system once the port is swiveled into position above the elbow. A port access that keeps the system substantially closed, even in use, would be very desirable. Further, it would be desirable to have such a system wherein any sealing mechanism could be easily removed and replaced.

### SUMMARY

There is provided a port sealing cartridge that allows for insertion of a catheter or other medical device into an endotracheal tube and thence the patient's lungs, through an available access port. The port sealing cartridge has a primary seal and a secondary seal or collar to help maintain cleanliness as well as to help maintain the pressure within the system when a device is inserted into the port. An optional tethered dust cover may also be used on the proximal end of the port seal cartridge. The port seal cartridge may desirably be fitted with a quick-connection on its distal end so that it may be easily removed from the port, disposed of and replaced. The port seal cartridge may be used for access to a patient's lungs with a bronchoalveolar catheter, bronchoscope or other medical device for treatment or sampling of the respiratory tract to aid in the diagnosis of ventilator acquired pneumonia or other ailments.

### BRIEF DESCRIPTION OF THE DRAWINGS

FIG. 1 shows a device which may be used to clear secretions from the lungs of a patient as described in U.S. Pat. No. 4,569,344.

FIG. 2 shows a multiple-access manifold mounted as described in U.S. Pat. No. 5,735,271 which may be placed between the tracheal care device of U.S. Pat. No. 4,569,344 and the ventilation circuit.

FIG. 3 shows a cross-sectional view of one embodiment of the port sealing cartridge described in the Summary without a catheter inserted.

FIG. 4 shows a cross-sectional view of one embodiment of the port sealing cartridge described in the Summary with a catheter inserted therethrough.

FIG. 5 shows a top view of one embodiment of the port sealing cartridge described in the Summary.

FIG. 6 shows a side view of one embodiment of the port sealing cartridge described in the Summary.

### DETAILED DESCRIPTION

Reference is now made to the drawings wherein like numerals are used to designate like parts throughout.

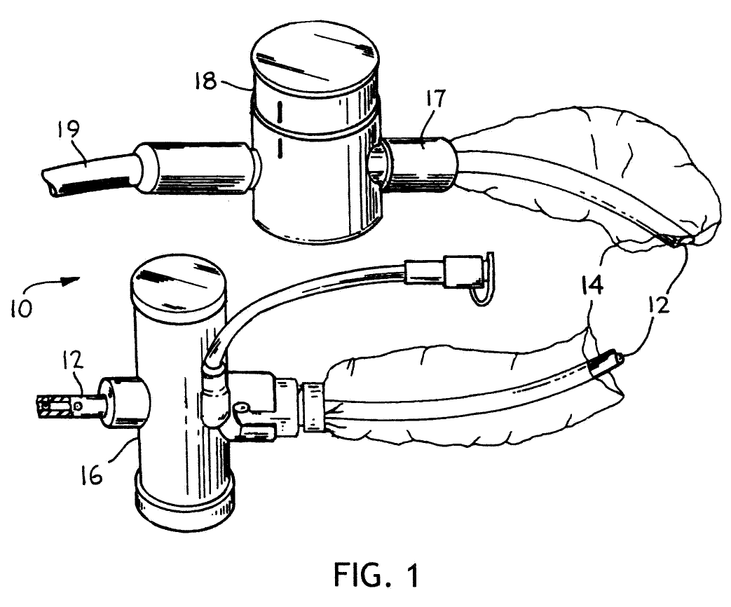

FIG. 1 illustrates an aspirating/ventilating apparatus disclosed U.S. Pat. No. 4,569,344, also referred to under the tradename TRACH CARE®. This closed suction catheter aspirating device 10 is attached to the patient's endotracheal tube using a fitting 16 and may be included as part of an overall ventilation circuit. The suction catheter 12 is enclosed within a plastic bag 14 to eliminate or minimize contamination of the catheter. As the patient requires artificial removal of secretions, the suction catheter is advanced through the fitting 16 of the ventilating device into the endotracheal tube (not shown), into the patient's airway and then into one of the lungs of the patient. Suction is applied using a finger controlled valve 18 on the proximal end of the catheter 12 to remove the secretions. A more detailed description of this care device may be found in U.S. Pat. No. 4,569,344.

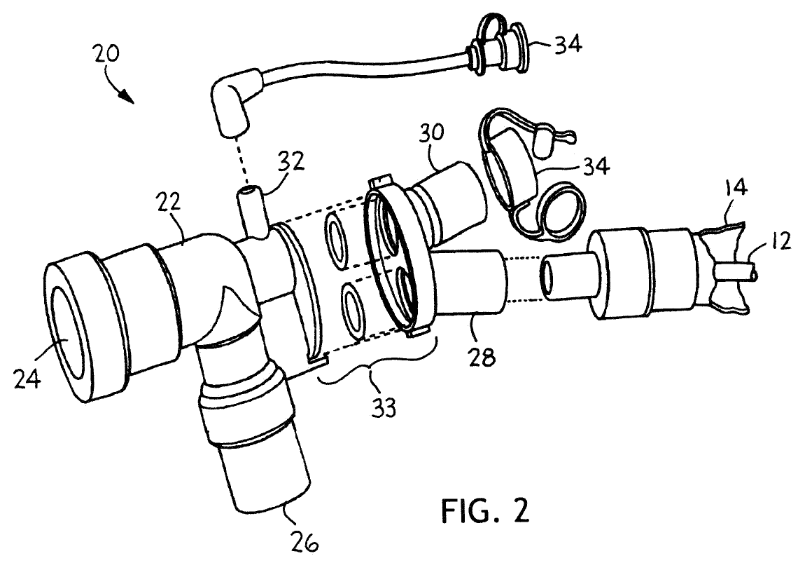

The closed suction aspirating device 10 of FIG. 1 may be used by attaching it directly to an endotracheal tube or in other configurations as long as it may move in a substantially straight alignment into the endotracheal tube. One of the ways the aspirating device 10 may be used is to attach it to a multiple-access manifold 20 like, for example, that shown in U.S. Pat. No. 5,735,271 (FIG. 2). The multiple-access manifold 20 has a rotating mechanism so that a user may choose which port is aligned with the endotracheal tube. As shown in FIG. 2, the manifold assembly accommodates continual cyclic patient ventilation, independent of implementation by the health care provider of any other patient respiratory access procedure. Access port 32 accommodates introduction of irrigation or wash liquid by which the exterior of an aspirating catheter 12, for example, is washed as the catheter 12 is withdrawn following use. The distal end 24 of the device is connected to an endotracheal tube (not shown) through which the patient is ventilated. Access port 26 may be connected to the ventilator and ports 28 and 30 may accommodate accessory devices. One device may be the aspirating catheter 12, for example, as shown adjacent to the port 28. The other port 30 may be used with the port seal as described in the Summary. When it is desired to use the aspirating device, the manifold may be rotated so that the catheter aligns with the distal port 24. The catheter 12 may be then advanced through the manifold and into the bronchial tube of the patient and suction may be applied as described previously. A more detailed description of this device may be found in U.S. Pat. No. 5,735,271.

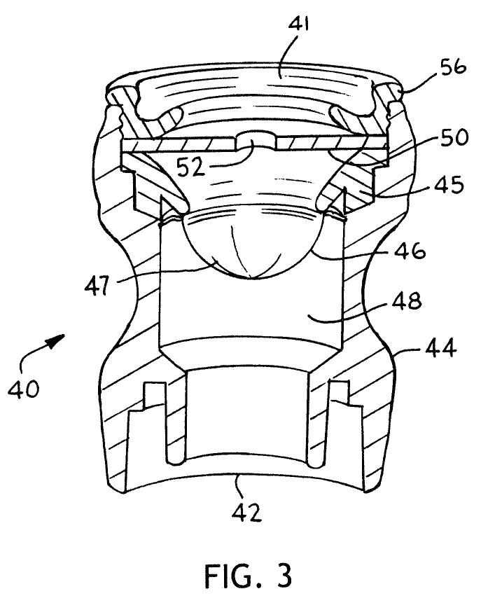

FIG. 3 is an illustration of the port seal cartridge described in the Summary as shown in cross-section. The port seal cartridge 40 has a proximal end 41 an open distal end 42 for attachment to an access port (not shown) on a ventilating system. The body 44 of the port seal cartridge 40 is sized and shaped to hold the primary seal 46 through which access to the patient's lungs may be made. The primary seal may be held in place by a primary seal retaining ring 45. Any other suitable means of holding the primary seal 46 in place may also be used.

The primary seal 46 may desirably define two slits 47 in an “X” shape in its center to accommodate the passage of medical devices like catheters. The exact shape and number of slits is unimportant, however, provided the slit shape is capable of closing and maintaining a seal. Other embodiments may, for example, use a single slit or 3, 4 or more slits, though an excessive number may inhibit the ability of the primary seal 46 to re-close after the medical device is withdrawn. The primary seal 46 must allow passage of medical devices of various sizes and it has been found that an “X” shaped slit can accommodate the passage of a wide variety of sizes and shapes. If no medical device is inserted through it, the primary seal 46 remains closed (i.e. sealed) as shown in FIG. 3 so the pressure of the ventilating system is maintained and leakage is minimal, if any. When a medical device is inserted, the slit(s) 47 is forced open and the primary seal 46 opens to allow passage of the device and pressure is no longer maintained in the ventilating system. The primary seal 46 may have an overall dome or hemispherical shape as shown in FIG. 3, though other shapes may be used. The primary seal is the seal towards the pressurized ventilating system.

A secondary seal or collar 50 defining an aperture 52, desirably centrally located, is fitted above (proximal to) the primary seal 46 in order to assist in maintaining the pressure in the system when a medical device is inserted. The secondary seal or collar 50 may be held in place with a retaining ring 56. The secondary seal or collar 50 may be substantially flat as compared to the primary seal 46 as seen in FIG. 3 though the this shape is not required. The aperture 52 is sized to approximately conform to a medical device. When a medical device is not inserted, the secondary seal or collar 50 does not form a closed seal and the aperture 52 remains open. Upon insertion of a medical device into the aperture 52, a seal is created by the walls of the aperture 52 as it comes in contact with the periphery of the medical device.

The primary and secondary seals thus have different resting or “standby” positions when a medical device is not inserted which reverse when a medical device is inserted. The primary seal standby position is normally closed while the secondary seal standby position is normally open. When a medical device is inserted into the port seal cartridge, first through the secondary seal and then through the primary seal, the seals are in use and not on standby, the primary seal is open and the secondary seal is closed.

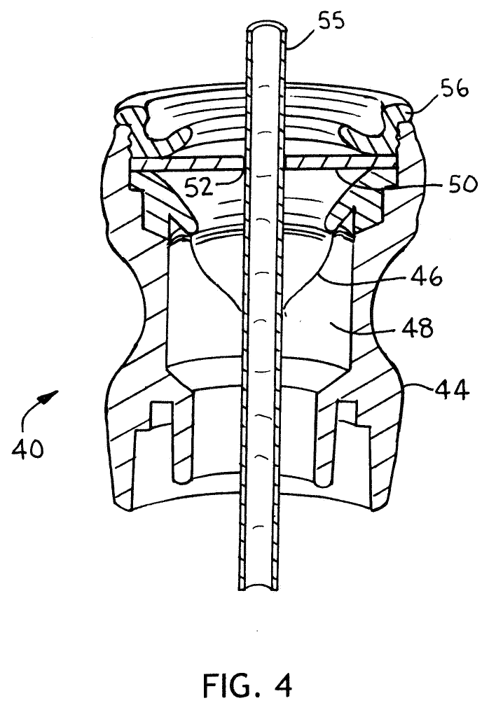

FIG. 4 is an illustration of the port seal cartridge described in the Summary as shown in cross-section with a catheter 55 inserted therethrough. As can clearly be seen, the aperture 52 of the secondary seal or collar 50 is completely filled by the catheter 55 and a seal is thus created. The primary seal 46 is now open to accommodate the catheter 55.

Above the secondary seal or collar 50 is an optional retaining ring 54 for a dust cap (not shown in FIGS. 3 and 4) to assist in maintaining a clean environment on the proximal end of the port seal cartridge 40.

The port seal cartridge 40 optionally has a chamber 48 below (distal to) the primary seal 46 where secretions scraped or wiped from a medical device as it is being withdrawn through the primary seal 46 may accumulate. As the medical device passes back through the primary seal 46 on its exit trip, the primary seal 46 scrapes or wipes the departing medical device. The secretions from the medical device will accumulate immediately below the primary seal 46 in the body chamber 48 as they are wiped off the medical device. If the port seal cartridge 40 is detachable, the port seal cartridge 40 may be disposed of, removing the secretions from the respiratory system and helping to reduce the risk of ventilator acquired pneumonia.

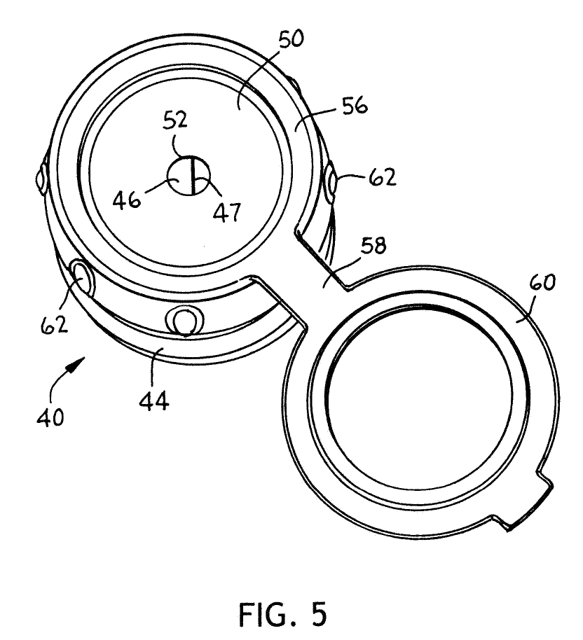

FIG. 5 is a view from the top (proximal end) 41 of the port seal cartridge 40. In this view one may see the retaining ring 56 and the fob 58 that connects to the dust cover 60 that may be use to close the top of the port seal cartridge 40 while it is not in use. Also visible in this view are the secondary seal or collar 50 and the aperture 52. Through the aperture 52 may be seen a portion of the primary seal 46 and a slit 47. The body 44 with grip dimples 62 is also visible in this Figure.

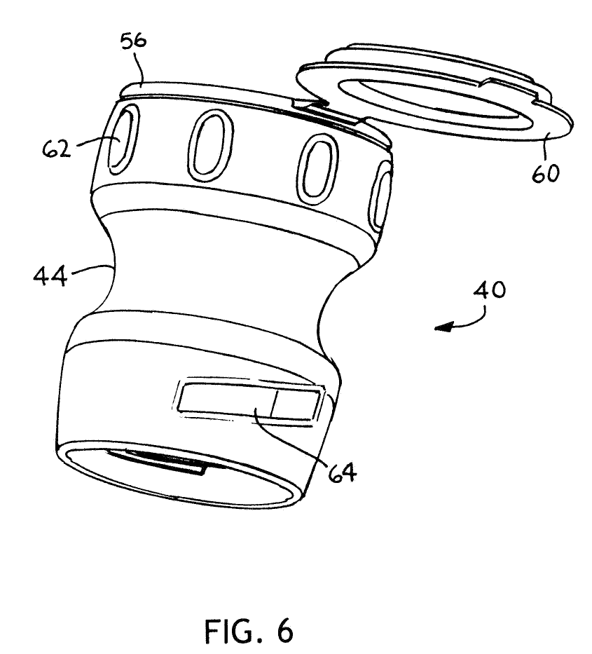

FIG. 6 is a view from the side of the port seal cartridge 40 showing the dust cover 60, retaining ring 56 and body 44. This view also illustrates the optional finger gripping dimples 62 which assist in turning and holding the port seal cartridge 40. Alternate shapes and textures may serve the same purpose as the finger gripping dimples 62 illustrated in FIG. 5. Diagonal or vertical slots or raised portions, a roughened band or two depressions on opposite sides of the port seal cartridge may be used to improve finger grip as well.

Also visible in FIG. 5 is a female fitting end 64 for a luer-type fitting as described in co-assigned, co-pending patent application ______, attorney docket number 64496506, filed on the same day as the instant application and incorporated by reference. This application describes a novel quick connect fitting having male and female fitting ends and a tapered internal luer-type seal. The male fitting end has a periphery upon which is mounted at least one boss. There may desirably be two bosses on the periphery of opposite sides of the male fitting end, and they may be of different lengths. The female fitting end has a slot into which the boss may be inserted. At the bottom of the slot is a stop to limit the insertion depth of the boss. The male and female ends may then be rotated relative to each other to move the boss into a window on the female end. The window has a frame and the upper frame is angled slightly which serves to draw the male end farther into the female end. The window has a side frame that stops the rotational movement of the boss. When the movement of the boss is stopped, the male and female tapers are in substantially leak-free contact. The boss on the male fitting end may desirably be at an a downward angle between 5 and 15 degrees, more particularly between 7 and 12 degrees and still more particularly between 9 and 10 degrees, relative to the perpendicular of the centerline of the fitting. The male and female fitting ends may be rotated relative to each other in a right hand turn orientation to tighten them, desirably for about a quarter turn though more or less may be desirable in particular applications. A left hand turn orientation may also be used if desired. In usage, once the boss of the male fitting end is inserted into the slot of the female fitting, it may advance only so far as to contact the stop at the bottom of the slot. The stop is placed at the proper depth so as to bring the luer tapers of the male and female fittings close together or into contact. Once the boss is fully inserted into the slot, the male fitting end may be rotated in only one direction relative to the female fitting to move the boss into position in the window. As the boss moves into the window, contact with the upper (angled) frame of the window causes the entire male fitting end to move slightly farther into the female fitting end. When the boss contacts the far window side frame, movement is stopped and the tapers of the male fitting end and the female fitting end are fully engaged and are in substantially leak-free contact.

Other quick connections may be used in place of the described and illustrated luer fitting. These may include bayonet fittings, snap fitting, threaded fittings, O-ring fittings and any other type of fitting that allows the detachable attachment of the port seal cartridge 40. It is also possible of course, though not desirable, to permanently attach the port seal cartridge 40 to a port. In this case the port seal cartridge 40 may not be removed for replacement.

Examples of the types of medical devices that may be inserted into the port seal cartridge and thence into the lungs include bronchoscopes and bronchoalveolar (BAL) catheters. The medical devices generally used for these purposes are between 10 and 20 French, more particularly between 15 and 20 French. One type of bronchoalveolar catheter is commercially available under the trade name BAL CATH® from Ballard Medical Products Inc., a division of Kimberly-Clark Corporation and may be used for lavage and sampling of the lungs to assist in the diagnosis of ventilator acquired pneumonia.

The materials of construction of the port seal cartridge may be conventional polymeric materials. It has been found, for example that the body 44 is desirably somewhat stiff and that medical grade polypropylene polymers function well in this service. An exemplary polypropylene is ProFax PD-626 polypropylene homopolymer having trace amounts of a proprietary stabilizer, that is available from Lyondell-Bassel Industries of Houston, Tex. Other materials from which the body may be made include polyethylene, acrylic, polyethylene terephthalate, polyurethane, nylon and styrene.

The primary seal 46 is desirably a commercially available one from LMS Inc. (Liquid Molding Systems Inc., a subsidiary of Aptar Group Inc.) of Midland Mich., as part number V43 and may be made from medical grade silicon. The primary seal retaining ring may be made from the same material(s) as the body. The secondary seal or collar 50 may also desirably be medical grade silicon and the aperture should be between 2 and 3 mm in diameter for most medical devices. The primary and secondary seals should be sized to allow the passage of medical devices between 10 and 20, more particularly between 15 and 20 French, in size. The retaining ring 54, fob 58 and dust cover 60 are desirably a single piece of material and it has been found that medical grade polyethylene functions well in this service though any other material having sufficient flexibility would also suffice. A suitable polyethylene is an ultra high molecular weight polymer GUR®-5113-UHMW-PE available from Ticona Engineering Polymers, a business of Celanese Corporation.

The dimensions of the port seal cartridge may be varied depending on the size of the port to which it is desired to attach the port seal cartridge. Exemplary dimensions for the device from the proximal to distal ends is between 20 and 25 mm with a diameter at its largest point of between 15 and 20 mm. It should also be noted that port seal cartridge may be circular but also may be shaped to match the port geometry.

In usage, a port seal cartridge may be fitted to a port on, for example, a multiple access manifold or other similar device by using a quick connect fitting like a luer or bayonet fitting, as shown in FIG. 6. The dust cover may be lifted and a bronchoscope, BAL CATH® device or other medical device may be inserted through the secondary seal or collar aperture. It is at this point that the sealing ability of the two seals working in concert is seen. As the device passes through the secondary seal or collar aperture, the walls of the aperture come in contact with the device. The aperture is generally circular, as are most of the medical devices that are inserted into the respiratory tract. The secondary seal or collar is also sufficiently pliable so that the device, even if somewhat larger than the aperture, can move through it without excessive force. The secondary seal or collar thus forms a seal against the outside walls of the medical device. The inserted medical device may be moved still farther through the primary seal. As the device passes through the primary seal, the slit opens. When the slit opens, the pressure seal that it had provided is lost. The secondary seal, however, provides the necessary sealing for the system and pressure loss is minimal, if at all. When the device is removed the process is reversed and the primary seal again provides the sealing necessary to maintain the system pressure. In this manner, the primary and secondary seals sequentially provide a pressure seal for a ventilating system while a medical device is inserted and removed. If the port on which the port seal cartridge is attached is aligned with the endotracheal tube, the medical device may be inserted still further, through the endotracheal tube and into one of the lungs of a patient. After the medical device has been used in the respiratory tract of a patient, it may be withdrawn along the same path used to insert it. As the medical device passes back through the primary seal on its exit trip, the primary seal scrapes or wipes the departing medical device. The secretions from the medical device tend to accumulate immediately below the primary seal in the body chamber as they are wiped off the medical device.

Once the medical device is completely removed from the port seal cartridge, the port seal cartridge may be removed from the port by disconnecting the quick connect by which it was attached to the port. The used port seal cartridge may be disposed of in an accepted manner so that any secretions that have accumulated in the body chamber are also removed from potential reintroduction to the patient. A new, unused port seal cartridge may be installed on the port so that it is ready for the next usage.

Modifications and variations of the presently disclosed device will be obvious to those of skill in the art from the foregoing detailed description. For example, though the discussion above mentions the insertion of catheters into the port seal cartridge, other devices such as cameras or other viewing devices may be inserted into the port seal cartridge as well provide they are of the appropriate size. Such modifications and variations are intended to come within the scope of the following claims.

I claim:

1. A port seal cartridge comprising a body having distal end and a proximal end and a primary seal and a secondary seal or collar therebetween adapted to allow passage of a medical device therethrough, said distal end being adapted to attach to a port, and; wherein said primary and secondary seals sequentially provide a pressure seal for a ventilation system when said medical device is inserted and removed.

2. The port seal cartridge of claim 1 wherein said body further comprises a chamber distal to the primary seal and adapted to receive secretions scraped from said medical device as it is withdrawn from said port seal cartridge.

3. The port seal cartridge of claim 2 wherein said primary seal defines a slit that remains closed when said medical device is not inserted.

4. The port seal cartridge of claim 3 wherein said secondary seal defines a circular aperture that remains open when said medical device is not inserted.

5. The port seal cartridge of claim 4 wherein said port seal cartridge has a dust cover mounted on said proximal end.

6. The port seal cartridge that is adapted to detachably attach to a port.

7. The port seal cartridge of claim 6 wherein said port seal cartridge is adapted to detachably attach to a port using a fitting system selected from the group consisting of luer fittings, bayonet fittings, snap fittings, threaded fittings, and o-ring fittings.

8. The port seal cartridge of claim 1 wherein said body is made from a polymer selected from the group consisting of acrylic, polyolefins, polyethylene terephthalate, polyurethane, nylon and styrene.

9. The port seal cartridge of claim 1 wherein said primary seal is made from silicone.

10. A disposable port seal cartridge comprising a body with a quick-connect fitting for attaching to a port on a manifold that is connected to an endotracheal tube on a proximal end of said endotracheal tube, said port seal cartridge having primary and secondary seals sequentially disposed and adapted to receive a medical device inserted therethrough, said primary seal being open when said medical device is inserted and said secondary seal being closed when said medical device is inserted.

11. The disposable port seal cartridge of claim 10 wherein said port seal cartridge seal is adapted to receive a bronchoalveolar device.

12. The disposable port seal cartridge of claim 10 wherein said body further comprises a chamber distal to said primary seal for accumulating secretions from said medical device as it is withdrawn from said port seal cartridge.
